(19) United States
(12) Patent Application Publication
(10) Pub. No.: US 2010/0284670 A1
(43) Pub. Date: Nov. 11, 2010

(54) METHOD, SYSTEM, AND APPARATUS FOR EXTRACTING VIDEO ABSTRACT

(75) Inventor: Shiping LI, Shenzhen (CN)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: Tencent Technology (Shenzhen) Company Ltd., Shenzhen (CN)

(21) Appl. No.: 12/839,518

(22) Filed: Jul. 20, 2010

Related U.S. Application Data
(63) Continuation of application No. PCT/CN2009/071953, filed on May 25, 2009.

(30) Foreign Application Priority Data
Jun. 30, 2008 (CN) 200810068209.6

(51) Int. Cl. H04N 5/93; G11B 27/00

(52) U.S. Cl. 386/278; 386/E05.028

(57) ABSTRACT

The present invention provides a method, system and apparatus for extracting a video abstract. The method includes: A: receiving an input video, dividing the video and obtaining a jump time point sequence; B: filtering out a jump time point sequence from candidate time point sequences by using a shot dividing algorithm; C: extracting a video segment corresponding to each jump time point according to the jump time point sequence, and merging the extracted video segments into a video abstract. In the procedure of extracting the video abstract in the present invention, an eigenvector of each video frame is calculated firstly, a jump time point sequence is filtered out through a hierarchical clustering mode, and then video frames are extracted according to the jump time point sequence to be merged into the video abstract.

### FIELD OF THE TECHNOLOGY

The present invention relates to electronic communication and video image processing technologies, and more particularly, relates to a method, system and apparatus for extracting a video abstract.

### BACKGROUND OF THE INVENTION

Along with the development of computer technologies and multimedia technologies, multimedia resources are increasingly rich. However, it is impossible for each person to browse all available multimedia resources because the person has no enough much time, and thus it is needed to rapidly find interested information from vast information resources. Similarly, when reading an article, a person may read an abstract at first, and then determines whether to be interested in the article; when browsing a plentiful of pictures, the person may browse abbreviated pictures at first, and then determines an interested picture. However, when the person watches a video, there is no effective method for the person to obtain information of the video rapidly and comprehensively. If the person only watches one segment of the video, or skips through the video by using a manual mode, the person can not obtain comprehensive information, and may miss a plentiful of important information.

Currently, there is a method and system for extracting a video abstract according to a video stream. The system includes a shot boundary detecting unit, a shot classifying unit and a wonderful shot detecting unit, as shown in FIG. 1. A procedure of extracting a video abstract based on the system is shown in FIG. 2, and includes the following processes.

In step S201, the shot boundary detecting unit receives an input video stream, performs shot boundary detection for the video stream by using a shot boundary detecting method based on sliding average window frame difference, and obtains a shot set. Herein, the shot boundary detecting method relates to a video content structure technology. Because such a problem that a video has no structure becomes a bottleneck hindering applications of a new generation video, the video content structure technology is provided by researchers to solve the problem. The video contents structure technology is divided into a low layer, a middle layer and a high layer; and the shot boundary detecting technology is one key technology in the video content structure analysis of the low layer and plays an important role in video index. A good shot boundary detecting technology is a solid foundation of the video content structure analysis, and makes it possible to perform semantics video processing of the higher layer.

In step S202, after receiving the shot set, the shot classifying unit performs shot classification for the shot set by using a shot classifying method based on a sub-window area. The shot boundary detecting technology used in the method is mainly applicable to sport games, and thus the step S202 related to sport games includes that: the shot classifying unit receives the shot set for which the boundary detection is performed, obtains a key frame of each shot, locates multiple sub-windows in the key frame according to a predetermined sub-window locating rule, calculates a percentage of stadium-color pixels and/or a percentage of edge pixels in each sub-window, and determines the type of the shot according to the percentage of stadium-color pixels and/or the percentage of edge pixels.

In step S203, the wonderful shot detecting unit performs wonderful shot detection for the classified shot set, and outputs detected wonderful shots as a video abstract. The method is mainly applicable to sport games, and thus the step S203 related to sport games includes that: the wonderful shot detecting unit receives the classified shot set and the video stream, extracts audio information, detects a key area of a stadium and the locations and distances of key objects, such as a distance between a goal and a football, detects whether there are hurrah, keywords and the like in the audio, and extracts the shots having the above elements to merge into the video abstract.

As can be seen, in the prior art, the shot set for which the boundary detection has been performed is obtained firstly, and then the shot classification and wonderful shot detection are performed based on the obtained shot set to extract the video abstract. However, the technology has following limitations: after the detection, the obtained wonderful shots can not cover as many shots as possible to obtain a most complete video abstract, so that user's requirements of obtaining comprehensive information can not be met; in addition, the shot boundary detecting technology has good robust for the movement of a camera and the entrance of a big object, but do not have universality, thereby only applicable to a certain type of videos, e.g. sport games and the like.

### SUMMARY OF THE INVENTION

An object of the present invention is to provide a method for extracting a video abstract, which can improve the universality of applications.

Another object of the present invention is to provide a system for extracting a video abstract, which can enhance information completeness of the video abstract and improve the universality of applications.

Another object of the present invention is to provide an apparatus for extracting a video abstract, which can enhance information completeness of the video abstract and improve the universality of applications.

The apparatus for extracting a video abstract includes a video dividing unit, a jump time point calculating unit and a video abstract merging unit;

the video dividing unit is adapted to divide a video and obtain candidate time point sequences;

the jump time point calculating unit is adapted to perform data interaction with the video dividing unit, and filter out a jump time point sequence from the candidate time point sequences; and

the video abstract merging unit is adapted to perform data interaction with the jump time point calculating unit, and extract a video segment corresponding to each jump time point according to the jump time point sequence, and merge the extracted video segments into a video abstract.

The system for extracting a video abstract, includes an input-output unit adapted to receive a video and output a video abstract, a video dividing unit, a jump time point calculating unit and a video abstract merging unit;

the video dividing unit is adapted to perform data interaction the input-output unit and divide the received video and obtain candidate time point sequences;

the jump time point calculating unit is adapted to perform data interaction with the video dividing unit, and filter out a jump time point sequence from the candidate time point sequences; and

the video abstract merging unit is adapted to perform data interaction respectively with the input-output unit and the jump time point calculating unit, and extract a video segment corresponding to each jump time point according to the jump time point sequence, merge the extracted video segments into a video abstract, and output the video abstract to the input-output unit.

The method for extracting a video abstract includes:

A: dividing a video and obtaining a jump time point sequence; and

B: extracting a video segment corresponding to each jump time point according to the jump time point sequence, and merging the extracted video segments into a video abstract.

As can be seen, the differences between the procedure of extracting the video abstract in the present invention and that in the prior art include that: dividing a video to obtain a jump time point sequence, extracting a video segment corresponding to each jump time point according to the jump time point sequence, merging the obtained video segments into a video abstract, and outputting the video abstract. In the present invention, video frames are filtered based on the divided video segments, without needing to consider the type of the video, so as to improve the universality of applications.

Moreover, in the present invention, the received video is divided to obtain candidate time point sequences, and then a jump time point sequence is filtered out from the candidate time point sequences by using a shot dividing algorithm; further, video frames corresponding to the jump time point sequence are extracted to be merged into a video abstract. In the present invention, the shot dividing algorithm is used to filter out the jump time point sequence, and video frames with the maximum difference corresponding to the jump time point sequence can be filtered out according to the characteristics of the shot dividing algorithm, so that the video frames can cover as many shots as possible and the image difference between the video frames is maximal, thereby enhancing information completeness of the video abstract.

### BRIEF DESCRIPTION OF THE DRAWINGS

FIG. 1 is a schematic diagram illustrating a structure of a system for extracting a video abstract in the prior art.

FIG. 2 is a flowchart illustrating a method for extracting a video abstract in the prior art.

FIG. 3 is a schematic diagram illustrating a structure of a system for extracting a video abstract in accordance with an embodiment of the present invention.

FIG. 4A is a schematic diagram illustrating candidate time points and jump time points of a video frame obtained after a video is divided in accordance with a first embodiment of the present invention.

FIG. 4B is a schematic diagram illustrating candidate time points and jump time points of a video frame obtained after a video is divided in accordance with a second embodiment of the present invention.

FIG. 5 is a schematic diagram illustrating a structure of an apparatus for extracting a video abstract in accordance with an embodiment of the present invention.

FIG. 6 is a schematic diagram illustrating an internal structure of a jump time point calculating unit in accordance with an embodiment of the present invention.

FIG. 7 is a schematic diagram illustrating an internal structure of a video abstract merging unit in accordance with an embodiment of the present invention.

FIG. 8 is a flowchart illustrating a method for extracting a video abstract in accordance with a first embodiment of the present invention.

FIG. 9 is a flowchart illustrating a method for extracting a video abstract in accordance with a second embodiment of the present invention.

FIG. 10 is a flowchart illustrating a method for filtering out a jump time point sequence from candidate time point sequences in accordance with an embodiment of the present invention.

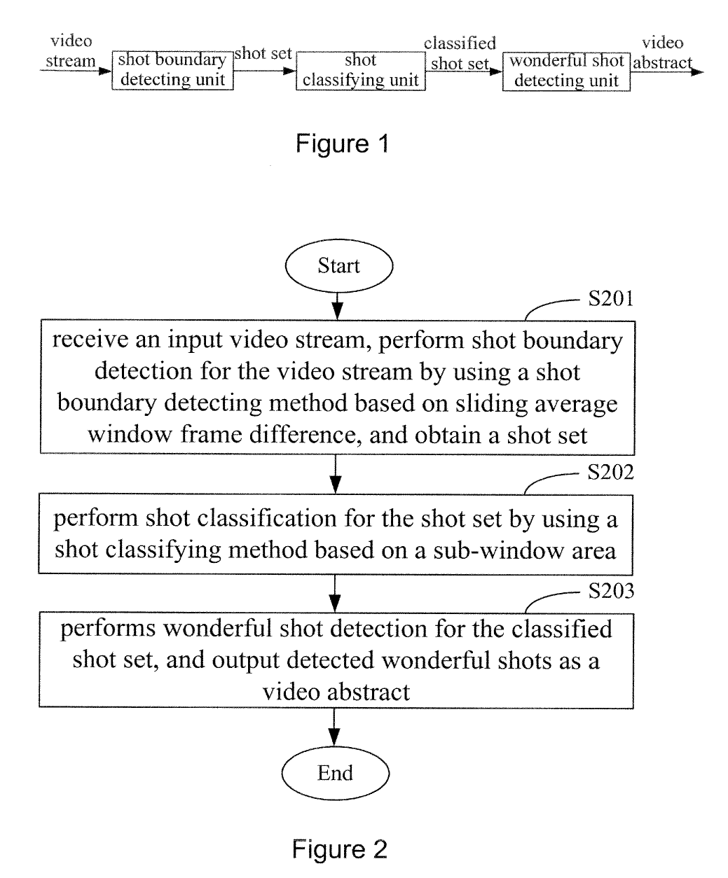

### DETAILED DESCRIPTION OF THE INVENTION

In order to make the objects, technical schemes and merits of the present invention clearer, the present invention will be illustrated in detail hereinafter with reference to the accompanying drawings and embodiments. It should be understood that the embodiments described herein are merely used to explain the present invention and are not used to limit the present invention.

Video fast-preview technologies are to obtain as much information as possible from a video in the shortest time. Take a film of 120 minutes as an example, suppose there are 30 shots in the film and each shot is 4 minutes averagely, it is required to obtain information of the film in 4 minutes. In a first method, it takes 4 minutes to watch one of the shots; in a second method, it takes 8 seconds to watch each shot, then a next shot is jumped to, and thus the total cost is 4 minutes. Obviously, more information will be obtained by using the second method. Therefore, the problem of video fast-preview becomes how to find a switch point between shots from the video. Characters of the shots include that: video images of two different shots have a big difference, while the difference between video frames in a shot is small, and thus the problem of the video fast-preview becomes how to find a series of video frames with the maximum image difference.

Thus the strategy of the present invention is as follows.

A video is divided to obtain a jump time point sequence, a video segment corresponding to each jump time point is extracted according to the jump time point sequence, the extracted video segments are merged into a video abstract, and the video abstract is output. In this way, in the embodiments of the present invention, video frames are filtered based on the divided video segments, without needing to consider the type of the video, so as to improve the universality of applications.

There are multiple methods for dividing the video to obtain the jump time point sequence, which are described hereinafter with reference to examples. The video may be randomly divided to obtain the jump time point sequence. The process of calculating the number M of jump time points is as follows: suppose video preview time is tₚ and video playback time at each jump time point is tⱼ, the number M of the jump time points is equal to tₚ/tⱼ. After the M is calculated, the video is randomly divided to obtain M jump time points which are taken as the jump time point sequence.

The received video may be divided to obtain candidate time point sequences, and then the jump time point sequence is filtered out from the candidate time point sequences by using a shot dividing algorithm. According to characteristics of the shot dividing algorithm, video frames with the maximum difference corresponding to the jump time point sequence can be filtered out, and thus the video frames can cover as many shots as possible and image difference between the video frames is maximal. Further, the shot dividing algorithm may include calculating an eigenvector of each video frame and filtering out the jump time point sequence from the candidate time point sequences by using a hierarchical clustering mode. It can be seen that if the video abstract is extracted according to the technical scheme of the present invention, information completeness is enhanced and user's requirements of obtaining comprehensive information are met.

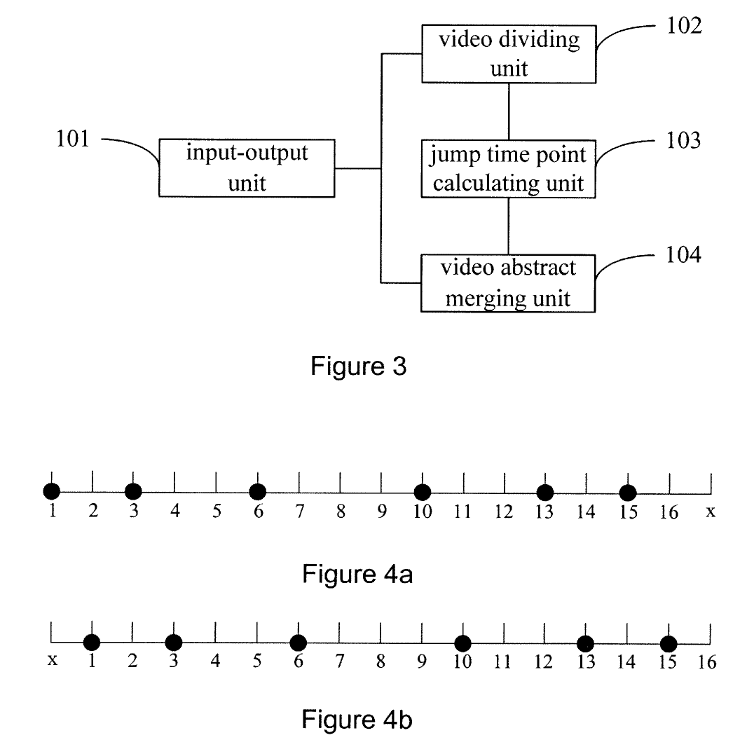

FIG. 3 is a schematic diagram illustrating a structure of a system for extracting a video abstract in accordance with an embodiment of the present invention. The system includes an input-output unit 101, a video dividing unit 102, a jump time point calculating unit 103 and a video abstract merging unit 104. It should be noted that, connection relations between apparatuses shown in all figures of the present invention are used to clearly describe information interaction and control processes, and should be regarded as logical connection relations instead of physical connection relations. In addition, it should be noted that, function modules may communicate with each other by using multiple modes, e.g. data communication may be performed through wireless modes such as Bluetooth, infrared ray and the like; of course, the data communication may also be performed through cable connections modes such as Ethernet lines, optical fibers and the like. Therefore, the protection scope of the present invention should not be limited to a certain type of communication mode.

(1) The input-output unit 101 performs data interaction respectively with the video dividing unit 102 and the video abstract merging unit 104, and is adapted to receive an input video, send the video to the video dividing unit 102, and output a video abstract extracted by the video abstract merging unit 104.

(2) The video dividing unit 102 performs data interaction with the input-output unit 101, and is adapted to divide the received video to obtain candidate time point sequences.

Generally, the video dividing unit 102 performs isometric division for the received video to obtain the candidate time point sequences. In this case, the process of calculating candidate time points is as follows: suppose the length of the video is tₘ and the number of the candidate time points is N, a duration dur between two candidate time points is tₘ/N, and the candidate time points are {xᵢ|xᵢ=dur×i, 0≦i<N}, where xᵢ represents the location of the i^{th} candidate time point. The candidate time points may refer to FIGS. 4A and 4B, in which the time points 1-16 are all the candidate time points. It should be noted that the candidate time points may be obtained by using other feasible modes which are not limited to the above isometric dividing mode.

(3) The jump time point calculating unit 103 performs data interaction with the video dividing unit 102, and is adapted to filter out a jump time point sequence from the candidate time point sequences by using the shot dividing algorithm. The jump time point in the present invention represents a time point at which one video segment is switched to a next video segment when fast preview. In the present invention, in order to enhance the information completeness of the video abstract, the jump time points are filtered out by following a principle as follows: the selected M (0<M<N) jump time points can cover as many shots as possible, and the image difference between the video frames corresponding to the jump time points is maximal. The process of calculating the number M of jump time points is as follows: suppose video preview time is tₚ and video playback time at each jump time point is tⱼ, the number M of the jump time points is equal to tₚ/tⱼ.

The jump time points may refer to FIGS. 4A and 4B, and the video frames corresponding to the jump time points may be extracted and may be merged into the video abstract. In an embodiment, the 1^{st}, 3^{rd}, 6^{th}, 10^{th}, 13^{th} and 15^{th} candidate time points are filtered out from 1-16 candidate time points and taken as the jump time points. There are two extracting solutions. In one extracting solution, if each time point corresponds to a video frame after the time point, the first time point may be taken as the jump time point, the last time point can not be taken as the jump time point, and thus the distribution of the filtered out jump time points is shown in FIG. 4A, herein the jump time points are displayed in highlight, and the video frames after the jump time points are extracted. In the other extracting solution, if each time point corresponds to a video frame before the time point, the first time point can not be taken as the jump time point, the last time point can be taken as the jump time point, and thus the distribution of the filtered out jump time points is shown in FIG. 4B, herein the jump time points are displayed in highlight, and the video frames before the jump time points are extracted. The process of extracting the jump time points will be described in detail in FIG. 6.

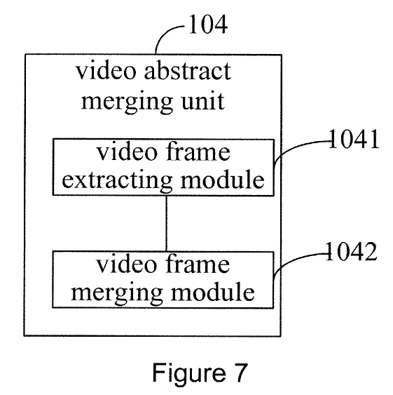

(4) The video abstract merging unit 104 performs data interaction respectively with the input-output unit 101 and the jump time point calculating unit 103, and is adapted to extract a video segment corresponding to each jump time point according to the jump time point sequence, merge the video segments into the video abstract and send the video abstract to the input-output unit 101. Details of the video abstract merging unit 104 will be described in FIG. 7.

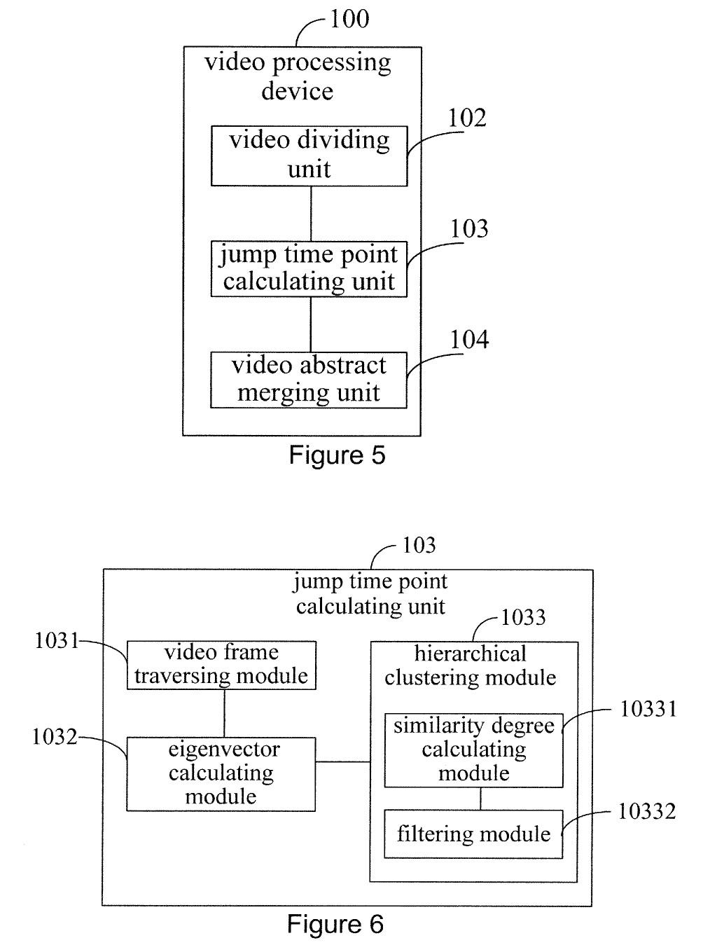

FIG. 5 is a schematic diagram illustrating a structure of an apparatus for extracting a video abstract in accordance with an embodiment of the present invention. The apparatus, i.e. a video processing apparatus 100, includes a video dividing unit 102, a jump time point calculating unit 103 and a video abstract merging unit 104.

(1) The video dividing unit 102 divides a video and obtains candidate time point sequences.

(2) The jump time point calculating unit 103 performs data interaction with the video dividing unit 102, and is adapted to filter out a jump time point sequence from the candidate time point sequences by using a shot dividing algorithm.

(3) The video abstract merging unit 104 performs data interaction with the jump time point calculating unit 103, and is adapted to extract a video segment corresponding to each jump time point according to the jump time point sequence, merge the extracted video segments into a video abstract and send the video abstract to the input-output unit 101.

The above function units are respectively identical with the function units in the system shown in FIG. 3, but compared with the system shown in FIG. 3, the video processing apparatus 100 is merely adapted to perform data processing for the video to obtain the video abstract. Therefore, the separated video processing apparatus 100 is more similar with a plug-in apparatus, and thus the application scope is more flexible and wider.

FIG. 6 is a schematic diagram illustrating an internal structure of a jump time point calculating unit 103 in accordance with an embodiment of the present invention. The jump time point calculating unit 103 includes a video frame traversing module 1031, an eigenvector calculating module 1032 and a hierarchical clustering module 1033.

(1) The video frame traversing module 1031 traverses the video frames, points to each current candidate time point, obtains a video frame corresponding to the candidate time point, determines whether there exists a next candidate time point, and if yes, points to the next candidate time point, until all the candidate time points are inquired.

(2) The eigenvector calculating module 1032 performs data interaction with the video frame traversing module 1031, calculates eigenvectors of the video frames corresponding to all candidate time points according to the video frames obtained by the video frame traversing module 1031. Since the video frame is a video image at a certain time point, and the eigenvector of the video frame indicates image characteristics of the video frame, the eigenvectors of the video frames are taken as a base of determining the difference between two video frames. In the present invention, there are many characters for indicating the video frame, which include an image color character, an image texture character, an image shape character, an image space relation character, an image high-dimension character and the like.

In an embodiment, the image color character is taken as an eigenvector of the video frame, and the calculating process is as follows: a video frame image is divided into four image blocks according to a level midline and a vertical midline; a histogram is extracted from each image block, where the histogram refers to a distribution curve of the image in each color value. In the embodiment, a maximum value in the histogram, a color value corresponding to the maximum value and a variance are taken as the eigenvectors of the image block.

Herein, the process of calculating the histogram is as follows: a vector set of the histogram is configured as {Hᵢ|0≦i≦255}, and each Hᵢ is initialized as zero; each pixel of the current image block is traversed; a gray value of the current pixel is calculated, i.e. val=(r+g+b)/3. Where, r, g and b respectively represent a color component of red, green and blue, i.e. Hᵥₐₗ=Hᵥₐₗ+1.

The maximum value of the histogram, i.e. Hᵢ with the maximum value, is calculated; the color value corresponding to the maximum value is the subscript i; a variance calculating formula (in which the xᵢ is replaced with the is as follows: if x̅ is an average value of a set of data x₁, x₂, x₃ . . . xₙ, and S² is the variance of the set of data,

$$\begin{matrix}{S}^{2} = \frac{1}{n} [ {( {x}_{1} - \overline{x} )}^{2} + {( {x}_{2} - \overline{x} )}^{2} + … + {( {x}_{n} - \overline{x} )}^{2} ] \\ = \frac{1}{n} [ {x}_{1}^{2} + {x}_{2}^{2} + … + {x}_{n}^{2} ) - n {\overline{x}}^{2} ] .\end{matrix}$$

Finally, the eigenvector of the video frame is obtained, i.e. s=[s₁, s₂, . . . , s₁₂]^{T}. Where, s₁, s₂, . . . s₁₂ respectively represent the maximum values of the histograms of the four image blocks, the color value corresponding to the maximum value and the variance.

In another embodiment, the image shape character is taken as an eigenvector of the video frame, the image shape characters generally include a boundary character, a Fourier shape descriptor, a shape invariable square and the like. In the embodiment, a boundary character method based on Hough transform is adopted, which includes the following steps: performing binaryzation for a frame image of the current video frame; performing Hough transform for the image after the binaryzation to obtain a Hough[p][t] matrix; calculating four maximum values in the Hough[p][t] matrix, and taking the four maximum values and the level and vertical locations of the four maximum values as the eigenvectors of the video frame. Herein, the object of the Hough transform is to transform pixels into a beeline, which may be expressed as y=k*x+b; a Hough matrix is obtained after the Hough transform, the level and vertical locations of elements in the matrix represent the parameters of the beeline, and the values of the parameters represent the number of pixels on the beeline. Details of the Hough transform may refer to the prior art. It should be noted that, the four maximum values in the Hough[p][t] matrix correspond to the most obvious four beelines in the image frame.

It should be noted that the above examples in which the image color character and the image shape character are taken as the eigenvectors of the video frame are merely two typical embodiments, and the protection scope of the present invention is not limited to the above examples.

(3) The hierarchical clustering module 1033 performs data interaction with the eigenvector calculating module 1032, and filters out the jump time point sequence from the candidate time point sequences according to the obtained eigenvectors by using a hierarchical clustering algorithm. In an embodiment, the hierarchical clustering module 1033 further includes a similarity degree calculating module 10331 and a filtering module 10332.

The similarity degree calculating module 10331 calculates similarity degree D_{i,j} between each two eigenvectors. Since there are N eigenvectors, there are C_{N}² values of the similarity degree D_{i,j} between each two eigenvectors. In an embodiment, the process of calculating the D_{i,j} is as follows: firstly N groups of eigenvectors are defined as {fᵢ|1≦i≦N}, where fᵢ represents the i^{th} eigenvector; and then the similarity degree between each two eigenvectors in the N groups of eigenvectors is calculated. There are multiple arithmetic operators for weighing the similarity degree, e.g. a euclidean distance, a mahalanobis distance, a probability distance and the like.

In an embodiment of the present invention, a probability absolute value distance is adopted, and the calculating process is as follows: suppose eigenvectors fᵢ and fᵢ corresponding to two video frames are respectively [sᵢ₁, sᵢ₂, . . . , sᵢ₁₂]^{T} and [sⱼ₁, sⱼ₂, . . . , sⱼ₁₂]^{T}, the distance is

$${D}_{i , j} = {\sum }_{k = 1}^{12} \vert Sik - Sjk \vert .$$

The smaller the D_{i, j} is, the more similar the fᵢ and fⱼ are, i.e. the more similar the two video frames corresponding to fᵢ and fⱼ are, vice versa. Herein, 0≦I, j≦N, i≠j, 0<M<N, N is the number of the candidate time points, i.e. the number of the eigenvectors, i and j respectively represent the i^{th} and j^{th} eigenvectors.

In another embodiment of the present invention, the euclidean distance is adopted, and the calculating formula is

$${D}_{i , j} = \sqrt{{\sum }_{k = 1}^{12} {( Sik - Sjk )}^{2}} .$$

It should be noted that, the examples of calculating the similarity degree between the eigenvectors by adopting the probability absolute value distance and the euclidean distance are merely two typical embodiments, and the protection scope of the present invention is not limited to the above implementation modes.

The filtering module 10332 filters out M candidate time points with the largest similarity degree D_{i,j} by comparing the similarity degree D_{i,j}, and obtain the jump time point sequence.

In an embodiment, the filtering module 10332 aggregates N species into M species, i.e. M jump time points, by using the hierarchical clustering algorithm. The detailed filtering process is as follows: a minimum value is found from C_{N}² characteristic distances, supposed as D_{m,n}; D_{m,i} and D_{n,i} are compared, (where, i is {i|1≦i≦nb, i≠m, i≠n}), the minimum value is given to the D_{m, i}, and D_{n, i} is deleted. After the above filtering process is performed once, characteristic distances correspond to the eigenvector fₙ are all deleted, i.e. N−1 eigenvectors and C_{N-1}² characteristic distances are left. The above hierarchical clustering process is kept on until M eigenvectors and C_{M}² characteristic distances are left, and the time points corresponding to the M eigenvectors are the M jump time points.

It should be noted that the filtering module 10332 may adopt other similar modes to filter out the jump time sequence, and the protection scope of the present invention is not limited to the above modes.

FIG. 7 is a schematic diagram illustrating an internal structure of a video abstract merging unit 104 in accordance with an embodiment of the present invention. The video abstract merging unit 104 performs data interaction with the jump time point calculating unit 102, extracts the video segment corresponding to each jump time point according to the jump time point sequence, and merges the extracted video segments into the video abstract.

In the embodiment, the video abstract merging unit 104 further includes a video frame extracting module 1041 and a video frame merging module 1042. The video frame extracting module 1041 extracts a video segment with the length of tⱼ at each jump time point, referring to FIGS. 4A and 4B. The video frame merging module 1042 orderly merges the M video segments with the length of tⱼ, and thus obtains a video abstract with the length of tₚ=tⱼ*M. Therefore, the procedure of extracting the video abstract with the length of tₚ from the video with the length of tₘ is finished, and a user can obtain basic information of the video by watching the video abstract with the length of tₚ, thereby implementing the fast preview of the video.

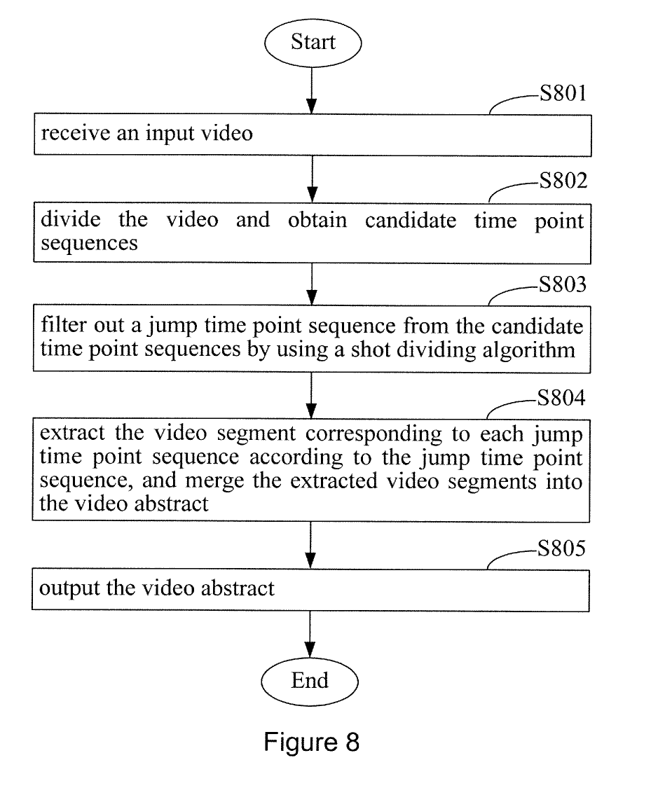

FIG. 8 is a flowchart illustrating a method for extracting a video abstract in accordance with a first embodiment of the present invention. The method may base on the system structure shown in FIG. 3 or the apparatus structure shown in FIG. 5. The method includes the following processes.

In step S801, the input-output unit 101 receives an input video. The video may be a video obtained by a user, a video extracted from a file stored locally or a video input by using any other modes.

In step S802, the video dividing unit 102 divides the video and obtains candidate time point sequences.

Generally, the video dividing unit 102 performs isometric division for the received video to obtain the candidate time point sequences. In this case, the process of calculating the candidate time points is as follows: suppose the length of the video is tₘ and the number of the candidate time points is N, a duration dur between two candidate time points is tₘ/N, and the candidate time points are {xᵢ|xᵢ=dur×i, 0≦i≦N}, where xᵢ represents the location of the i^{th} candidate time point. The candidate time points may refer to FIGS. 4A and 4B, in which the time points 1-16 are all the candidate time points. It should be noted that the candidate time points may be obtained by using other feasible modes which are not limited to the above isometric dividing mode.

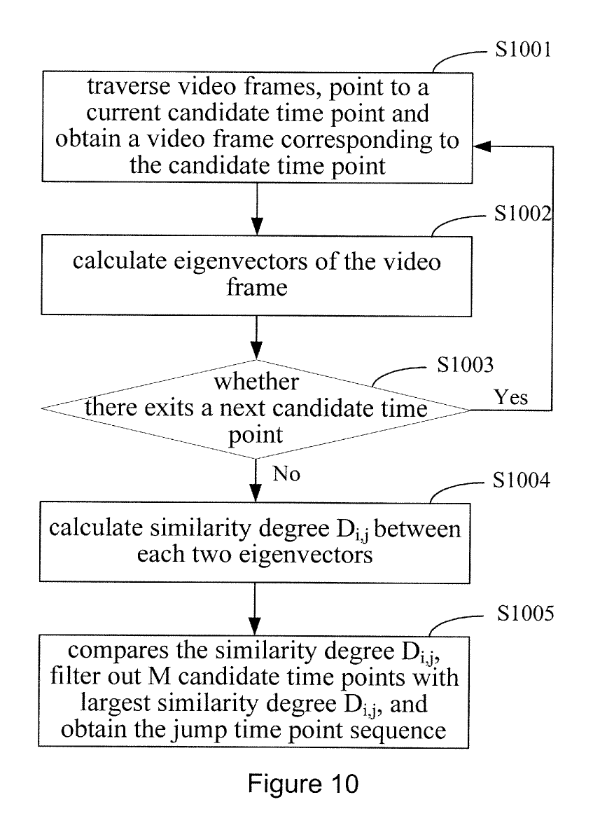

In step S803, the jump time point calculating unit 103 filters out a jump time point sequence from the candidate time point sequences by using a shot dividing algorithm. The jump time point in the present invention represents a time point at which one video segment is switched to a next video segment when fast preview. The process of calculating the number M of jump time points is as follows: suppose video preview time is tₚ and video playback time at each jump time point is tⱼ, the number M of the jump time points is equal to tₚ/tⱼ. Detailed process of the step S803 may refer to the contents shown in FIG. 10.

The jump time points may refer to FIGS. 4A and 4B, and the video frames corresponding to the jump time points may be extracted and may be merged into the video abstract. In an embodiment, the 1^{st}, 3^{rd}, 6^{th}, 10^{th}, 13^{th} and 15^{th} candidate time points are filtered out from 1-16 candidate time points and taken as the jump time points. There are two extracting solutions. In one extracting solution, if each time point corresponds to a video frame after the time point, the first time point may be taken as the jump time point, and the last time point can not be taken as the jump time point, and thus the distribution of the filtered out jump time points is shown in FIG. 4A, herein the jump time points are displayed in highlight, and the video frames after the jump time points are extracted. In the other extracting solution, if each time point corresponds to a video frame before the time point, the first time point can not be taken as the jump time point, and the last time point can be taken as the jump time point, and thus the distribution of the filtered out jump time points is shown in FIG. 4B, herein the jump time points are displayed in highlight, and the video frames before the jump time point are extracted. The process of extracting the jump time points will be described in detail in FIG. 6. Detailed process of the step S803 will be described in FIG. 10.

In step S804, the video abstract merging unit 104 extracts the video segment corresponding to each jump time point according to the jump time point sequence, and merges the extracted video segments into the video abstract. Specifically, the video frame extracting module 1041 extracts a video segment with the length of tⱼ at each jump time point, referring to FIGS. 4A and 4B. The video frame merging module 1042 orderly merges the M video segments with the length of tⱼ, and thus obtains the video abstract with the length of tₚ=tⱼ*M. Afterwards, the procedure of extracting the video abstract with the length of tₚ from the video with the length of tₘ is finished, and a user can obtain basic information of the video by watching the video abstract with the length of tₚ, thereby implementing the fast preview of the video.

In step S805, the input-output unit 101 outputs the video abstract obtained by the video abstract merging unit 104.

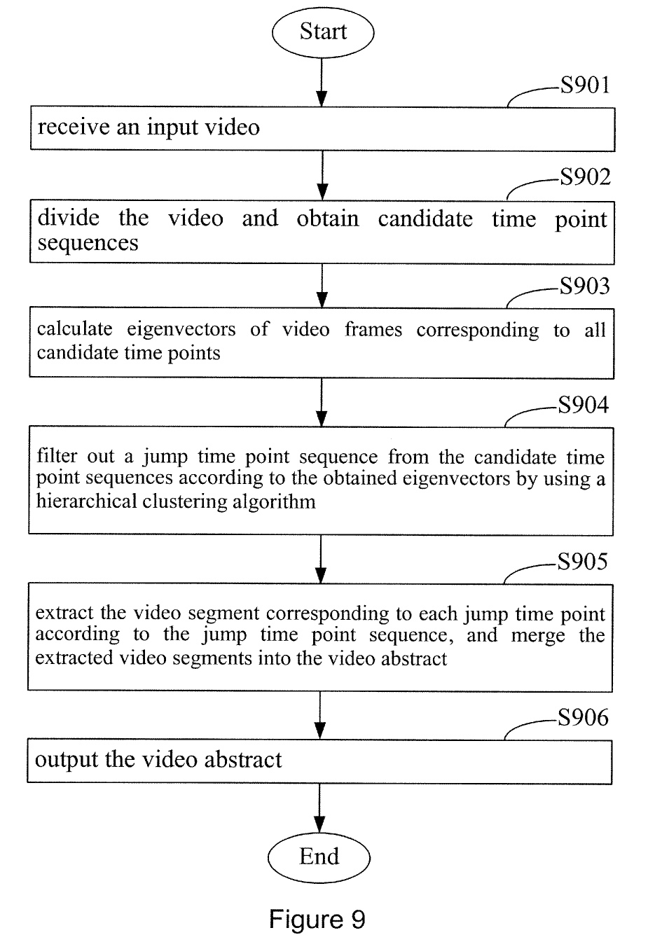

FIG. 9 is a flowchart illustrating a method for extracting a video abstract in accordance with a second embodiment of the present invention. The method may base on the system structure shown in FIG. 3 or the apparatus structure shown in FIG. 5. The method includes the following processes.

In step S901, the input-output unit 101 receives an input video. The video may be a video obtained by a user, a video extracted from a file stored locally or a video input by using any other modes. The protection scope of the present invention is not limited to a certain type of video input source or an input mode.

In step S902, the video dividing unit 102 divides the video and obtains candidate time point sequences. The detailed process of the step S902 is identical with that of the step S802, and is not described in detail herein.

In step S903, the jump time point calculating unit 103 calculates eigenvectors of video frames corresponding to all candidate time points.

In step S904, the jump time point calculating unit 103 filters out a jump time point sequence from the candidate time point sequences according to the obtained eigenvectors by using a hierarchical clustering algorithm.

In step S905, the video abstract merging unit 104 extracts the video segment corresponding to each jump time point according to the jump time point sequence, and merges the extracted video segments into the video abstract. The detailed process of the step S905 is identical with that of the step S804, and is not described in detail herein.

In step S906, the input-output unit 101 outputs the video abstract obtained by the video abstract merging unit 104.

FIG. 10 is a flowchart illustrating a method for filtering out a jump time point sequence from candidate time point sequences in accordance with an embodiment of the present invention. The method bases on the step S803 in the method shown in FIG. 8, and the step is mainly performed by the jump time point calculating unit 103 and includes the following processes.

In step S1001, the jump time point calculating unit 103 traverses video frames through the video frame traversing module 1031, points to a current candidate time point and obtains a video frame corresponding to the candidate time point.

In step S1002, the eigenvector calculating module 1032 calculates eigenvectors of the video frame. Since the video frame is a video image at a certain time point, the eigenvector of the video frame indicates image characteristics of the video frame, and thus the eigenvectors are taken as a base of determining the difference between two video frames. In the present invention, there are many characters for indicating the video frame, which include an image color character, an image texture character, an image shape character, an image space character, an image high-dimension character and the like.

In an embodiment, the image color character is taken as an eigenvector of the video frame, and the calculating process is as follows: a video frame image is divided into four image blocks according to a level midline and a vertical midline; a histogram is extracted from each image block, where the histogram refers to a distribution curve of the image in each color value. In the embodiment, a maximum value in the histogram, a color value corresponding to the maximum value and a variance are taken as the eigenvectors of the image block.

Herein, the process of calculating the histogram is as follows: a vector set of the histogram is configured as {Hᵢ| 0≦i≦255}, and each Hᵢ is initialized as zero; each pixel of the current image block is traversed; a gray value of the current pixel is calculated, i.e. val=(r+g+b)/3. Where, r, g and b respectively represent a color component of red, green and blue, i.e. Hᵥₐₗ=Hᵥₐₗ+1.

The maximum value of the histogram, i.e. Hᵢ with the maximum value, is calculated; the color value corresponding to the maximum value is the subscript i; a variance calculating formula (in which the xᵢ is replaced with the Hᵢ) is as follows: if x̅ is an average value of a set of data x₁, x₂, x₃ . . . xₙ, and S² is the variance of the set of data,

$$\begin{matrix}{S}^{2} = \frac{1}{n} [ {( {x}_{1} - \overline{x} )}^{2} + {( {x}_{2} - \overline{x} )}^{2} + … + {( {x}_{n} - \overline{x} )}^{2} ] \\ = \frac{1}{n} [ {x}_{1}^{2} + {x}_{2}^{2} + … + {x}_{n}^{2} ) - n {\overline{x}}^{2} ] .\end{matrix}$$

Finally, the eigenvector of the video frame is s=[s₁, s₂, . . . , s₁₂]^{T}. Where, s₁, s₂, . . . , s₁₂ respectively represent the maximum values of the histograms of the four image blocks, the color value corresponding to the maximum value and the variance.

In another embodiment, the image shape character is taken as an eigenvector of a video frame, the image shape characters generally include a boundary character, a Fourier shape descriptor, a shape invariable square and the like. In the embodiment, a boundary character method based on Hough transform is adopted, which includes the following steps: 1. performing binaryzation for a frame image of the current video frame; performing Hough transform for the image after the binaryzation to obtain a Hough[p][t] matrix; calculating four maximum values in the Hough[p][t] matrix, and taking the four maximum values and the level and vertical locations of the four maximum values as the eigenvectors of the video frame. Herein, the object of the Hough transform is to transform pixels into a beeline, which may be expressed as y=k*x+b; a Hough matrix is obtained after the Hough transform, the level and vertical locations of the elements in the matrix represent the parameters of the beeline, and the values of the parameters represent the number of pixels on the beeline. Details of the Hough transform may refer to the prior art. It should be noted that, the four maximum values in the Hough[p][t] matrix correspond to the most obvious four beelines in the image frame.

It should be noted that, it is merely two typical embodiments that the above image color character and image shape character are taken as the eigenvectors of the video frame, and the protection scope of the present invention is not limited to the above implementation modes.

In step S1003, the video frame traversing module 1031 determines whether there exists a next candidate time point; if yes, step S1001 is performed; otherwise, step S804 is performed.

In step S1004, the hierarchical clustering module 1033 calculates similarity degree D_{i,j} between each two eigenvectors through the similarity degree calculating module 10331. Since there are N eigenvectors, there are C_{N}² values of the similarity degree D_{i,j} between each two eigenvectors. In an embodiment, the process of calculating the D_{i,j} is as follows: firstly N groups of eigenvectors are defined as {fᵢ|1≦i≦N}, where fᵢ represents the i^{th} eigenvector; and then the similarity degree between each two eigenvectors in the N groups of eigenvectors is calculated. There are multiple arithmetic operators for weighing the similarity degree, e.g. a euclidean distance, a mahalanobis distance, a probability distance and the like.

In an embodiment of the present invention, a probability absolute value distance is adopted, and the calculating process is as follows: suppose eigenvectors fᵢ and fᵢ corresponding to two video frames are respectively [sᵢ₁, sᵢ₂, . . . sᵢ₁₂]^{T} and [sⱼ₁, sⱼ₂, . . . , sⱼ₁₂]^{T}, the distance is

$${D}_{i , j} = {\sum }_{k = 1}^{12} \vert Sik - Sjk \vert .$$

The smaller the D_{i, j} is, the more similar the fᵢ and fⱼ are, i.e. the more similar the two video frames corresponding to and fᵢ and fⱼ are, vice versa. Herein, 0≦I, j≦N, i≠j, 0<M<N, N is the number of the candidate time points, i.e. the number of the eigenvectors, i and j respectively represent the i^{th} and j^{th} eigenvectors.

In another embodiment of the present invention, the euclidean distance is adopted, and the calculating formula is

$${D}_{i , j} = \sqrt{{\sum }_{k = 1}^{12} {( Sik - Sjk )}^{2}} .$$

It should be noted that, the examples of calculating the similarity degree between the eigenvectors by adopting the probability absolute value distance and the euclidean distance are merely two typical embodiments, and the protection scope of the present invention is not limited to the above implementation modes.

In step S1005, the hierarchical clustering module 1033 compares the similarity degree D_{i,j} through the filtering module 10332, filters out M candidate time points with largest similarity degree D_{i,j}, and obtains the jump time point sequence.

In an embodiment, the filtering module 10332 aggregates N species into M species, i.e. M jump time points, by using the hierarchical clustering algorithm. The detailed filtering process is as follows: a minimum value is found from C_{N}² characteristic distances, supposed as D_{m, n}; D_{m, i} and D_{n, i} are compared, (where, i is {i|1≦i≦nb, i≠m, i≠n}), the minimum value is given to the D_{m, i}, and D_{n, i} is deleted. After the above filtering process is performed once, characteristic distances correspond to the eigenvector fₙ are all deleted, i.e. N−1 eigenvectors and C_{N-1}² distances are left. The above hierarchical clustering process is kept on until M eigenvectors and C_{M}² characteristic distances are left, and the time points corresponding to the M eigenvectors are the M jump time points.

It should be noted that the filtering module 10332 may adopt other similar modes to filter out the jump time sequence, and the protection scope of the present invention is not limited to the above modes.

It is can be seen that, in the procedure of extracting the video abstract provided by the present invention, the eigenvector of each video frame is obtained firstly, the jump time point sequence is filtered out by using a hierarchical clustering mode, and then video frames corresponding to the jump time point sequence are extracted to be merged into the video abstract, so that the video frames can cover with as many shots as possible and the image difference between the video frames is maximal, thereby enhancing information completeness of the video abstract. In addition, in the present invention, the video frames are filtered based on the divided video segments, without needing to consider the type of the video, so as to improve the universality of applications.

The foregoing are only preferred embodiments of the present invention and are not for use in limiting the protection scope of the present invention. Any modification, equivalent replacement and improvement made within the scope of the present invention should be covered under the protection scope of the present invention.

1. An apparatus for extracting a video abstract, comprising a video dividing unit, a jump time point calculating unit and a video abstract merging unit; wherein
the video dividing unit is adapted to divide a video and obtain candidate time point sequences;
the jump time point calculating unit is adapted to perform data interaction with the video dividing unit, and filter out a jump time point sequence from the candidate time point sequences; and
the video abstract merging unit is adapted to perform data interaction with the jump time point calculating unit, and extract a video segment corresponding to each jump time point according to the jump time point sequence, and merge the extracted video segments into a video abstract.

2. The apparatus of claim 1, wherein the video dividing unit is adapted to perform isometric division for the video and obtain the candidate time point sequences.

3. The apparatus of claim 2, wherein the jump time point calculating unit comprises a video frame traversing module, a eigenvector calculating module and a hierarchical clustering module;
the video frame traversing module is adapted to traverse video frames, point to each current candidate time point, obtain a video frame corresponding to the current candidate time point;
the eigenvector calculating module is adapted to perform data interaction with the video frame traversing module, and calculate eigenvectors of the video frames corresponding to all candidate time points according to the video frames obtained by the video frame traversing module; and
the hierarchical clustering module is adapted to perform data interaction with the eigenvector calculating module, and filter out the jump time point sequence from the candidate time point sequences according to the obtained eigenvectors by using a hierarchical clustering algorithm.

4. The apparatus of claim 3, wherein the hierarchical clustering module comprises a similarity degree calculating module and a filtering module; and
the similarity degree calculating module is adapted to calculate similarity degree Di,j between each two eigenvectors;
the filtering module is adapted to filter out M candidate time points with largest similarity degree Di,j by comparing the similarity degree Di,j, and obtain the jump time point sequence;
where, 0≦i, j≦N, i≠j, 0<M<N, N is the number of the eigenvectors, and i and j respectively represent the i^{th} and j^{th} eigenvector.

5. A system for extracting a video abstract, comprising an input-output unit adapted to receive a video and output a video abstract, a video dividing unit, a jump time point calculating unit and a video abstract merging unit; wherein
the video dividing unit is adapted to perform data interaction the input-output unit and divide the received video and obtain candidate time point sequences;
the jump time point calculating unit is adapted to perform data interaction with the video dividing unit, and filter out a jump time point sequence from the candidate time point sequences; and
the video abstract merging unit is adapted to perform data interaction respectively with the input-output unit and the jump time point calculating unit, and extract a video segment corresponding to each jump time point according to the jump time point sequence, merge the extracted video segments into a video abstract, and output the video abstract to the input-output unit.

6. A method for extracting a video abstract, comprising:
A: dividing a video and obtaining a jump time point sequence; and
B: extracting a video segment corresponding to each jump time point according to the jump time point sequence, and merging the extracted video segments into a video abstract.

7. The method of claim 6, wherein the step A comprises: randomly dividing the video and obtaining the jump time point sequence.

8. The method of claim 6, wherein the step A comprises:
A1: dividing the video and obtaining candidate time point sequences; and
A2: filtering out the jump time point sequence from the candidate time point sequences.

9. The method of claim 8, further comprising: receiving the video before the step A1.

10. The method of claim 8, wherein the step A1 comprises:
performing isometric division for the video and obtaining the candidate time point sequences.

11. The method of claim 9, wherein the step A1 comprises:
performing isometric division for the video and obtaining the candidate time point sequences.

12. The method of claim 10, wherein the step A2 comprises:
A21: calculating eigenvectors of video frames corresponding to all candidate time points; and
A22: filtering out the jump time point sequence from the candidate time point sequences according to the obtained eigenvectors by using a hierarchical clustering algorithm.

13. The method of claim 12, wherein the step A21 comprises:
A211: traversing the video frames, pointing to the first candidate time point, obtaining a video frame corresponding to the first candidate time point;
A212: calculating an eigenvector of the video frame; and
A213: determining whether there exists a next candidate time point; if there exists a next candidate time point, performing step A211; otherwise, performing step A22.

14. The method of claim 12, wherein the step A22 comprises:
A221: calculating similarity degree Di,j between each two eigenvectors;
A222: filtering out M candidate time points with largest similarity degree Di,j by comparing the similarity degree Di,j, and obtaining the jump time point sequence;
where, 0≦i, j≦N, i≠j, 0<M<N, N is the number of the eigenvectors, and i and j respectively represent the i^{th} and j^{th} eigenvector.
